(19) United States
(12) Patent Application Publication
(10) Pub. No.: US 2025/0003578 A1
(43) Pub. Date: Jan. 2, 2025

(54) LIGHTING DEVICES, LIGHTING DEVICE ASSEMBLIES, AND METHODS OF ASSEMBLING LIGHTING DEVICES AND LIGHTING DEVICE ASSEMBLIES

(71) Applicant: Korrus, Inc., Los Angeles, CA (US)

(72) Inventors: Yaote HUANG, Los Angeles, CA (US); Elizabeth RODGERS, Long Beach, CA (US); Robert FLETCHER, Pasadena, CA (US)

(73) Assignee: Korrus, Inc., Los Angeles, CA (US)

(21) Appl. No.: 18/345,216

(22) Filed: Jun. 30, 2023

(51) Int. Cl. F21V 19/00; F21V 23/02

(52) U.S. Cl. CPC F21V 19/003; F21V 23/02; F21Y 2103/10; F21Y 2115/10

(57) ABSTRACT

A lighting device assembly comprising a plurality of semiconductor light-emitting devices on a first side of a base, the first side of the base and a second side of the base (opposite the first side) are the largest sides of the base, and are both substantially flat and substantially rectangular, and a length of the first side is at least four times a width of the first side. Also, a lighting device assembly comprising a plurality of semiconductor light-emitting devices on a first side of a base, which base is an entirety of a one-piece structure, and for each of first and second sides of the base, at least 75 percent of points on an exterior of the first side and a second side of the base are base-obstruction-free in at least 80 percent of all directions away from the respective side. Also, methods of making lighting device assemblies.

### FIELD OF THE INVENTION

The present invention relates to the field of lighting devices, including lighting devices that include semiconductor light-emitting devices and lenses.

### BACKGROUND

Numerous lighting devices, e.g., those that include semiconductor light-emitting devices and lenses, have been developed. As examples, some of such lighting systems include lenses for controlling propagation of light emitted by semiconductor light-emitting devices. Despite the existence of these lighting systems, further improvements are still needed in lighting devices.

### BRIEF SUMMARY OF THE INVENTION

This section (i.e., “Brief Summary of the Invention”) presents a simplified summary of the present invention in order to provide a basic understanding of some aspects of the invention. Included in this section are some concepts of the invention as a prelude to more detailed descriptions of aspects of the present invention, and representative embodiments in accordance with aspects of the present invention.

Many LED lighting products (in particular, outdoor-capable accent linear LED lighting products) strive to provide satisfactory (or excellent) characteristics including the following four:
1) thermal dissipation:
2) electrical safety;
3) mechanical robustness; and
4) sealing from the environment (e.g., weather sealing, particularly with outdoor-capable devices).

For example, in some commonly available conventional products, efforts to satisfy these needs are accomplished by providing a housing in the form of a unitary extrusion with openings in an upper and lower face (or in some cases, just the upper face) in which to install the electronics and other components of the lighting devices. A unitary body is used in such devices because it has been deemed to be important for the mounting surface for the LED PCB to have a continuous heat conduction path (i.e., including no gaps or interfaces between elements) to the outside walls (e.g., of aluminum) of the housing. FIG. 10 schematically Illustrates cross-sections of two representative types of conventional lighting devices (each device including a unitary extrusion 100, an LED PCB and optics assembly 101 and a power supply driver assembly 102).

In such devices, because the LED PCB (LED circuit board) and optics need to be assembled through the tops of these open-faced single-body extrusions, a significant amount of time is spent on the assembly line, and special jigs are required for alignment, connector mating, and in some cases precision soldering. Connections being made between the PSU/driver (power supply unit/driver) and LED PCB represent a challenge because (in the case of an open bottom) the extrusion needs to be rotated to have access from one side or the other, and whichever side is upside-down needs to have its contents secured in some way, so they do not fall out during the assembly process. In situations in which a closed bottom housing is used, wiring and interconnects need to be fed from the end of the extrusion through the body of the extrusion to the other side for pass-through power.

In other devices (e.g., lighting systems disclosed in U.S. Pat. No. 9,651,227), schematically depicted in FIG. 11, the housing is separated into two housing elements 103 (housing the LED PCB and optics assembly 107) and 104 (housing the power supply/driver assembly 108) with a pivot 105 between them, allowing for each element to be assembled separately. In such systems, the interconnect 106 between the two housings requires connection, and necessarily requires water sealing, at an added expense and a greater level of complication.

One aspect of the present invention is a recognition that LED efficacy has recently reached such a high level (even when using up to 50% greater input power than in prior or existing devices) that a continuous thermal path from the LED PCB mounting surface to the outside walls can be sacrificed in favor of providing access, unobstructed by, e.g., portions of a body extrusion, to elements and components of the lighting device, particularly during assembly. In accordance with this aspect of the present invention, a central base (spine) is provided, on which or to which all of the elements and components of the lighting device are mounted or attached. By providing a central base (spine) on which or to which all of the elements and components of the lighting device are mounted or attached, although there is no continuous thermal path to the outer walls of the housing, several important improvements are provided:
Universal components: The same base (i.e., central plate or spine) and housing for the PSU/driver can be used in different lighting device designs (i.e., different combinations of light emitters, LED PCBs, lenses, etc. can be used with the same base and PSU/driver housing).
Ease of assembly: By eliminating the need for assemblers on the factory line to adhere, assemble, and interconnect PSU assemblies and LED PCBs in the bottom of troughs allows for faster assembly times. Additionally, weather sealing gaskets are accessible during installation (rather than being buried at the bottom of an extrusion trough) allowing for easier verification of quality sealing. For example, in prior designs: some elements (like the lenses on a four-foot long fixture) had to be loaded from the end, which was a lot like stuffing a sausage; the LED PCB had to be adhered to the original housing first, such that feeding the lenses in from the end risked knocking over components and damaging the PCBA, and was time-inefficient. With everything out in the open in accordance with the present invention, these sorts of concerns are eliminated.
Optical shielding: With existing devices, the entire optical assembly shone light through a unitary tertiary lens, whereas with some of the devices in accordance with the present invention, each optical cavity has an individual TIR (total internal reflection) secondary lens that is exposed, while intervening spaces between optics where stray light might escape are not, which leads to a cleaner optical distribution with fewer striations. For example, in some embodiments in accordance with the present invention, the first housing (upper housing) has portholes (one for each of the LED optics), which block extraneous light from the optical assembly, making the light output more consistent, and limiting striations.

In other words, rather than building a product into an extrusion with three faces (an open-faced tube) where everything needs to be assembled in a recessed area with limited access, lighting devices in accordance with the present invention are built around a central base. The central base allows open access to both sides of the base, i.e., to one side (e.g., the top of the base) (where the PCBA with LEDs and the DC/DC circuitry are located) and to the opposite side (e.g., the bottom of the base) (where the AC/DC power supply is located). Interconnections can be made between these two assemblies in the open, without operators having to reach down into an extrusion recess to make connections, insure proper alignment, verify the seal of gaskets, etc. In some embodiments in accordance with the present invention, once the electronics are all assembled, then the first housing (e.g., the upper housing), with portholes to allow the optics to show through, and the second housing (e.g., the lower housing), are mounted to the pre-assembled spine. In some embodiments, the first housing and/or the second housing are held in place with end caps.

FIG. 12 schematically depicts, in the left part of FIG. 12, a lighting device assembly in accordance with the present invention (comprising a base 109, an LED PCB and optics assembly 110 on one side of the base 109, and a power supply/driver assembly 111 on the other side of the base 109), prior to attaching a first housing element 112 and a second housing element 113 (upper and lower housing elements in the orientation shown), and, in the right part of FIG. 12, a lighting device after the first housing element 112 and the second housing element 113 have been attached to the base 109. The result is a product that is assembled from the inside out, rather than the outside in.

In accordance with a first aspect of the present invention, there is provided a lighting device assembly comprising:
a base; and
a plurality of semiconductor light-emitting devices,
the plurality of semiconductor light-emitting devices are on a first side of the base,
the first side of the base is opposite a second side of the base,
the first side of the base and the second side of the base are the largest sides of the base,
the first side of the base and the second side of the base are both substantially flat and substantially rectangular, and
a length of the first side of the base is at least four times a width of the first side of the base.

In some embodiments in accordance with the first aspect of the present invention, including some embodiments that include or do not include any of the features described herein:
the length of the first side of the base is at least ten inches, and
the width of the first side of the base is not greater than three inches (e.g., representative dimensions for the base can be one foot×2 inches, or four feet×2 inches).

In some embodiments in accordance with the first aspect of the present invention, including some embodiments that include or do not include any of the features described herein, a thickness of the base, in a direction that is perpendicular to the first side of the base and the second side of the base, is not greater than one tenth of the length of the first side of the base.

In some embodiments in accordance with the first aspect of the present invention, including some embodiments that include or do not include any of the features described herein:
the lighting device assembly further comprises circuitry that carries current through each of the plurality of semiconductor light-emitting devices, and circuitry (power supply) that converts AC voltage to DC voltage,
the circuitry that carries current through each of the plurality of semiconductor light-emitting devices is on the first side of the base, and
the circuitry that converts AC voltage to DC voltage is on the second side of the base.

In some embodiments in accordance with the first aspect of the present invention, including some embodiments that include or do not include any of the features described herein, the plurality of semiconductor light-emitting devices are all arranged in a row.

In some embodiments in accordance with the first aspect of the present invention, including some embodiments that include or do not include any of the features described herein:
the lighting device assembly further comprises a first housing element and a second housing element,
the lighting device assembly comprises at least a first internal compartment and a second internal compartment,
the first internal compartment is defined at least in part by the first housing element and the first side of the base,
the plurality of semiconductor light-emitting devices are in the first internal compartment, and
the second internal compartment is defined at least in part by the second housing element and the second side of the base.

In some embodiments in accordance with the first aspect of the present invention, including some embodiments that include or do not include any of the features described herein:
the lighting device assembly further comprises a first circuit board,
the first circuit board is on the first side of the base,
the plurality of semiconductor light-emitting devices are on the first circuit board,
the lighting device assembly further comprises a second circuit board, and
the second circuit board is on the second side of the base.

In some embodiments in accordance with the first aspect of the present invention, including some embodiments that include or do not include any of the features described herein:
the lighting device assembly further comprises a first housing element and a porthole lens element,
the first housing element comprises a plurality of portholes,
at least some light emitted from the plurality of semiconductor light-emitting devices passes through lens portions of the porthole lens element and through the portholes, and
at least some of the light emitted from the plurality of semiconductor light-emitting devices that passes through the lens portions of the porthole lens element is blocked by the first housing element.

In some embodiments in accordance with the first aspect of the present invention, including some embodiments that include or do not include any of the features described herein, one or more additional semiconductor light-emitting devices can be provided in other locations, and/or one or more additional light emitters can be provided at any location.

In accordance with a second aspect of the present invention, there is provided a lighting device assembly comprising:
a base; and
a plurality of semiconductor light-emitting devices,
the plurality of semiconductor light-emitting devices are on a first side of the base,
the base comprises an entirety of a one-piece structure,
at least 75 percent of points on an exterior of the first side of the base are base-obstruction-free in at least 80 percent of all directions away from the first side, and
at least 75 percent of points on an exterior of the second side of the base are base-obstruction-free in at least 80 percent of all directions away from the second side.

In some embodiments in accordance with the second aspect of the present invention, including some embodiments that include or do not include any of the features described herein:
the first side of the base and the second side of the base are both substantially flat and substantially rectangular, and
a length of the first side of the base is at least four times a width of the first side of the base.

In some of such embodiments, a thickness of the base, in a direction that is perpendicular to the first side of the base and the second side of the base, is not greater than one tenth of the length of the first side of the base.

In some embodiments in accordance with the second aspect of the present invention, including some embodiments that include or do not include any of the features described herein:
a length of the first side of the base is at least ten inches, and
a width of the first side of the base is not greater than three inches.

In some embodiments in accordance with the second aspect of the present invention, including some embodiments that include or do not include any of the features described herein:
the lighting device assembly further comprises circuitry that carries current through each of the plurality of semiconductor light-emitting devices, and circuitry that converts AC voltage to DC voltage,
the circuitry that carries current through each of the plurality of semiconductor light-emitting devices is on the first side of the base,
the circuitry that converts AC voltage to DC voltage is on a second side of the base, and
the second side of the base is opposite the first side of the base.

In some embodiments in accordance with the second aspect of the present invention, including some embodiments that include or do not include any of the features described herein, the plurality of semiconductor light-emitting devices are all arranged in a row.

In some embodiments in accordance with the second aspect of the present invention, including some embodiments that include or do not include any of the features described herein:
the lighting device assembly further comprises a first housing element and a second housing element,
the lighting device assembly comprises at least a first internal compartment and a second internal compartment,
the first internal compartment is defined at least in part by the first housing element and the first side of the base,
the plurality of semiconductor light-emitting devices are in the first internal compartment,
the second internal compartment is defined at least in part by the second housing element and a second side of the base, and
the second side of the base is opposite the first side of the base.

In some embodiments in accordance with the second aspect of the present invention, including some embodiments that include or do not include any of the features described herein:
the lighting device assembly further comprises a first circuit board,
the first circuit board is on the first side of the base,
the plurality of semiconductor light-emitting devices are on the first circuit board,
the lighting device assembly further comprises a second circuit board,
the second circuit board is on the second side of the base, and
the second side of the base is opposite the first side of the base.

In some embodiments in accordance with the second aspect of the present invention, including some embodiments that include or do not include any of the features described herein:
the lighting device assembly further comprises a first housing element and a porthole lens element,
the first housing element comprises a plurality of portholes,
at least some light emitted from the plurality of semiconductor light-emitting devices passes through lens portions of the porthole lens element and through the portholes, and
at least some light emitted from the plurality of semiconductor light-emitting devices passes through the lens portions of the porthole lens element is blocked by the first housing element.

In some embodiments in accordance with the second aspect of the present invention, including some embodiments that include or do not include any of the features described herein, one or more additional semiconductor light-emitting devices can be provided in other locations, and/or one or more additional light emitters can be provided at any location.

In accordance with a third aspect of the present invention, there is provided a method of making a lighting device assembly, comprising:
mounting a plurality of semiconductor light-emitting devices on a first circuit board;
attaching the first circuit board to a base, the base comprising a first side and a second side, the first side of the base is opposite the second side of the base, the first side of the base and the second side of the base are the largest sides of the base, the first side of the base and the second side of the base are both substantially flat and substantially rectangular, and a length of the first side of the base is at least four times a width of the first side of the base;
attaching a first housing element to the base, so that the first circuit board and the plurality of semiconductor light-emitting devices are within a space defined by the first housing element and the base;
mounting a power supply on a second circuit board:
attaching the second circuit board to a second side of the base; and
attaching a second housing element to the base, so that the second circuit board and the power supply are within a space defined by the second housing element and the base,
wherein:
said attaching a first housing element to the base is performed after said attaching the first circuit board to the first side of the base, and after said mounting the plurality of semiconductor light-emitting devices on the first circuit board, and
said attaching a second housing element to the base is performed after said mounting the power supply on the second circuit board, and after said attaching the second circuit board to the second side of the base.

In some embodiments in accordance with the third aspect of the present invention, including some embodiments that include or do not include any of the features described herein, the method further comprises:
attaching an interconnection assembly to the base and electrically connecting wires in the interconnection assembly to the second circuit board before at least one of said attaching the first housing element to the base and said attaching the second housing element to the base;
positioning a harness assembly in the second housing element, and electrically connecting wires in the harness assembly to components on the second circuit board before said attaching the second housing element to the base; and
before said attaching the first housing element to the base, positioning a porthole lens element such that upon said attaching the first housing element to the base, the porthole lens element is within the space defined by the first housing element and the base.

In some embodiments in accordance with the third aspect of the present invention, including some embodiments that include or do not include any of the features described herein, the method further comprises:
before said attaching the first housing element to the base, positioning a lens holder and a plurality of lenses such that upon said attaching the first housing element to the base, the lens holder and the plurality of lenses are within the space defined by the first housing element and the base.

In some embodiments in accordance with the third aspect of the present invention, including some embodiments that include or do not include any of the features described herein, the method further comprises:
before said attaching the first housing element to the base, positioning a reflection element such that upon said attaching the first housing element to the base, the reflection element is within the space defined by the first housing element and the base.

In some embodiments in accordance with the third aspect of the present invention, including some embodiments that include or do not include any of the features described herein, the second housing element comprises a second housing element first portion and a second housing element second portion, and the harness assembly is positioned in the second housing element second portion before the second housing element is attached to the base.

The invention may be more fully understood with reference to the accompanying drawings and the following detailed description of the invention.

### BRIEF DESCRIPTION OF THE DRAWING FIGURES

FIG. 1 is an exploded schematic view of a first embodiment of a lighting device 10 in accordance with the present invention.

FIG. 2 is an exploded schematic view of a second embodiment of a lighting device 50 in accordance with the present invention.

FIG. 3 is a schematic perspective view of the lighting device 10 (assembled).

FIGS. 4-9 are schematic views of a partially-assembled lighting device corresponding to the lighting device 10, at various stages of its assembly.

FIG. 10 schematically illustrates cross-sections of two representative types of conventional lighting devices.

FIG. 11 schematically illustrates another representative type of conventional lighting device.

FIG. 12 schematically depicts, in the left part of FIG. 12, a lighting device assembly in accordance with the present invention, prior to attaching a first housing element 112 and a second housing element 113, and, in the right part of FIG. 12, a lighting device after the first housing element 112 and the second housing element 113 have been attached to the base 109.

### DETAILED DESCRIPTION OF THE INVENTION

The expression “invention” is used herein to refer to any portion (or portions) of the inventive subject matter disclosed herein. As described herein, the present invention includes many aspects.

The expression “comprises” or “comprising” is used herein in accordance with its well known usage, and means that the item that “comprises” the recited elements (or that is “comprising” the recited elements) includes at least the recited elements, and can optionally include any additional elements. For example, an item that comprises “first and second housing elements” includes at least two housing elements, i.e., it can include two housing elements, three housing elements or more than three housing elements; an item that comprises a lens holder can include a single lens holder or a plurality of lens holders.

The expression “embodiment,” as used herein, means an embodiment in accordance with the present invention, i.e., an embodiment that is encompassed within the present invention.

Where an expression is defined herein in terms of the meaning of the expression in the singular, the definition applies also to the plural (and vice-versa, i.e., for an expression defined herein in the plural, the definition applies also to the singular). Definitions of one form of an expression apply to the same expression in a different form of the word or words.

As used herein, the singular forms “a”, “an” and “the” are intended to include the plural forms as well, unless the context clearly indicates otherwise.

Although the terms “first”, “second”, etc. may be used herein to describe various elements or components, such elements or components are not limited by these terms. These terms are only used to distinguish one element or component from another. Thus, a first element or component discussed herein could be termed a second element or component without departing from the teachings of the present inventive subject matter.

Relative terms, such as “lower” and “upper” may be used herein to describe one element's relationship to another element (or to other elements), e.g., as illustrated in the Figures. Such relative terms are intended to encompass different orientations of the device in addition to the orientation depicted in the Figures and/or as described herein. For example, if a device is turned over, elements described as being on the “lower” side of other elements would then be oriented on “upper” sides of the other elements. The exemplary term “lower” can therefore encompass both an orientation of “lower” and “upper,” depending on the particular orientation. Similarly, if a device is turned over, elements described as “below” or “beneath” other elements would then be oriented “above” the other elements.

Recitation herein that an element is “on”, is “mounted on”, is “mounted to”, or “extends onto” another element (e.g., “semiconductor light-emitting devices are on a first side of the base”), means that it can be in or on the other element, and/or it can be directly on the other element, and/or it can extend directly onto the other element, and it can be in direct contact or indirect contact with the other element (e.g., intervening elements may also be present). In addition, a statement that a first element is “on” a second element is synonymous with a statement that the second element is “on” the first element.

The term “plurality,” as used herein, means two or more, i.e., it encompasses two, three, four, five, etc. For example, the expression “a plurality of semiconductor light-emitting devices” encompasses two semiconductor light-emitting devices, three semiconductor light-emitting devices, four semiconductor light-emitting devices, etc.

The expression “substantially flat,” as used herein (e.g., in the expression “the first side of the base and the second side of the base are both substantially flat and rectangular”), means that at least 90 percent of the points in the surface which is characterized as being substantially flat are located on one of or between a pair of planes that are parallel to each other and that are spaced from each other by a distance of not more than 5 percent of the largest dimension of the surface.

The expression “substantially rectangular,” as used herein (e.g., in the expression “the first side of the base and the second side of the base are both substantially flat and rectangular”), means that a rectangular shape can be identified, wherein at least 90 percent of the points in the item which is characterized as being substantially rectangular fall within the rectangular shape, and the surface area of the item is at least 90 percent as large as the surface area of the rectangular shape.

The expression “arranged in a row”, as used herein in the context of a plurality of items being arranged in a row (e.g., in the expression “the plurality of semiconductor light-emitting devices are all arranged in a row”) means that there are at least two of the items, and there is at least one imaginary line that extends through each of the items.

The expression “opposite,” as used herein in relation to “opposite sides” of something (e.g., “the second side of the base is opposite the first side of the base”), means that a first plane, defined by at least three points on one of the sides, and a second plane, defined by at least three points on the other side, are parallel or could be made parallel by tilting one of the planes by not more than 40 degrees (and in some cases, by not more than 30 degrees, not more than 20 degrees, or not more than 10 degrees).

The expression “defines an internal space (or compartment)”, as used herein (e.g., in the expression “a space defined by a respective reflective portion of the reflection element 51, a respective one of the lens portions 28, and a respective one of the portholes 31”), means that the item or items that “define the internal space” completely surround the internal space, or that the item or items that “define the internal space” plus one or more imaginary planes (each imaginary plane defined by at least three points on the item or items) completely surround the internal space. For example, a five-sided rectilinear box (with an open top side) defines an internal space that would be completely surrounded by the box if a sixth side (top side) of the box were added that is contiguous with the tops of the sides of the five-sided box. Similarly, a shape with a bottom horizontal hexagonal side and six sidewalls of equal size, each extending upright from one of the six sides, with each sidewall having a circular opening, defines an internal space. Likewise, a generally prismatic shape of rectangular or square cross-section, with gaps, cracks and openings (e.g., through which wires extend from outside the shape to inside the shape), defines an internal space.

An expression that a space or compartment is “defined at least in part” by a structure or structures, as used herein (e.g., in the expression “the first internal compartment is defined at least in part by the first housing element and the first side of the base”) means that the structure or structures by itself or themselves, or in combination with one or more other structures, defines the internal space or compartment.

An expression that a first element is “attached” to a second element does not require that the first element be in direct contact with the second element (i.e., there can be one or more intervening elements).

The expression “substantially surrounds,” as used herein, means that the structure or structures that “substantially surround” an item occupy at least 95 percent of the surface area of an imaginary shape that completely surrounds the item.

The expression “axis of light emission”, as used herein in connection with light output from one or more light emitters, means any of several axes (in some cases, two or more of the axes are co-linear), including: (1) an axis along the maximum brightness of light emission from the light emitter, (2) an axis along a mean ray of light emission, (3) an axis that is perpendicular to a substantially flat light-emitting surface of the light emitter, and (4) an axis that is perpendicular to a tangent of a light-emitting surface of the light emitter at a center of the light-emitting surface. A mean ray of light emission is determined by factoring the respective brightnesses of light emitted in each light ray (i.e., each ray in which light is emitted assigned a weight equal to the brightness of light emitted along that ray). A light emitter includes one or more semiconductor light-emitting devices, and a light emitter can further comprise one or more luminescent materials and/or one or more reflectors.

The combination of the expressions:
“the base comprises an entirety of a one-piece structure,”
“at least 75 percent of points on an exterior of the first side of the base are base-obstruction-free in at least 80 percent of all directions away from the first side,” and
“at least 75 percent of points on an exterior of the second side of the base are base-obstruction-free in at least 80 percent of all directions away from the second side,”
   as used herein, means that:
for each of at least 75 percent of the points on the first side of the base, from among all imaginary rays that extend from the point in any direction that extends away from an imaginary plane (i.e., that do not intersect the imaginary plane at any location that is spaced from the point), the imaginary plane being a plane that encompasses a largest dimension of the base and a largest transverse dimension of the base (the “largest transverse dimension of the base” being the dimension that, from among all the other dimensions of the base, is the largest one that extends in a direction that is perpendicular to the largest dimension of the base), at least 80 percent of the imaginary rays do not intersect (i.e., are devoid of any intersection) with any other point on the base, and
for each of at least 75 percent of the points on the second side of the base, from among all imaginary rays that extend from the point in any direction that extends away from the imaginary plane (i.e., that do not intersect the imaginary plane at any location that is spaced from the point) (the second side of the base being opposite the first side of the base, so these imaginary rays extend from the opposite side of the imaginary plane), at least 80 percent of the imaginary rays do not intersect (i.e., are devoid of any intersection) with any other point on the base.
   The combination of these expressions encompasses an arrangement in which:
a combination of a first housing element, the base, a first portion of a first end cover and a first portion of a second end cover substantially define a first hollow prism (e.g., of rectangular cross-section), in which the base corresponds to only a single substantially flat side of the first hollow prism, and
a combination of a second housing element, the base, a second portion of the first end cover and a second portion of the second end cover substantially define a second hollow prism (e.g., of rectangular cross-section), in which the base corresponds to only a single substantially flat side of the second hollow prism.

The expression “collimate,” as used herein, means to increase the percentage of light rays that are substantially parallel to a forward direction. For example, the expression “lenses . . . receive light at one end, . . . and . . . collimate the light” means that a percentage of light rays that exit the lenses that are substantially parallel to the forward direction is greater than the percentage of light rays that entered the lenses. The expression “forward direction,” as used herein, means any particular direction, e.g., a direction in which light is desired to be directed.

Unless otherwise defined, all terms (including technical and scientific terms) used herein have the same meaning as commonly understood by one of ordinary skill in the art to which this invention belongs. Terms and expressions, such as those defined in commonly used dictionaries, should each be interpreted as having a meaning that is consistent with their meaning in the context of the relevant art and the present disclosure, and not in an idealized or overly formal sense (unless expressly so defined herein).

As noted above, lighting device assemblies and lighting devices in accordance with the present invention each comprise a base and a plurality of semiconductor light-emitting devices.

The base can be made of any suitable material or combination of materials, e.g., metal (such as aluminum, or steel (e.g., stainless steel), cast iron, etc.), plastic (such as polycarbonate, ABS or PVC), or fiberglass.

As noted above, in some embodiments, a length of the first side of the base is at least four times a width of the first side of the base, and/or at least 75 percent of points on each of an exterior of the first side of the base (and an exterior of the second side of the base) are base-obstruction-free in at least 80 percent of all directions away from the first side (and the second side, respectively). The base can have any other desired additional dimensional features or shapes, e.g., in some of such embodiments, the length of the first side of the base is at least ten inches, the width of the first side of the base is not greater than three inches, a thickness of the base can be not greater than one tenth of the length of the first side of the base, etc.

A wide variety of semiconductor light-emitting devices are suitable for use in the lighting device assemblies and lighting devices in accordance with the present invention. The expression “semiconductor light-emitting device” (also abbreviated as “SLED”), as used herein, means: a light-emitting diode; an organic light-emitting diode; a laser diode; or any other light-emitting device having one or more layers containing inorganic and/or organic semiconductor(s). Throughout this specification, the term “light-emitting diode” (herein also referred to as an “LED”) means: a two-lead semiconductor light source having an active pn-junction. As examples, an LED may include a series of semiconductor layers that may be epitaxially grown on a substrate such as, for example, a substrate that includes sapphire, silicon, silicon carbide, gallium nitride or gallium arsenide. Further, for example, one or more semiconductor p-n junctions may be formed in these epitaxial layers. When a sufficient voltage is applied across the p-n junction, for example, electrons in the n-type semiconductor layers and holes in the p-type semiconductor layers may flow toward the p-n junction. As the electrons and holes flow toward each other, some of the electrons may recombine with corresponding holes, and emit photons. The energy release is called electroluminescence, and the color of the light, which corresponds to the energy of the photons, is determined by the energy band gap of the semiconductor. As examples, a spectral power distribution of the light generated by an LED may generally depend on the particular semiconductor materials used and on the structure of the thin epitaxial layers that make up the “active region” of the device, being the area where the light is generated. As examples, an LED may have a light-emissive electroluminescent layer including an inorganic semiconductor, such as a Group III-V semiconductor, examples including: gallium nitride; silicon; silicon carbide; and zinc oxide. Throughout this specification, the term “organic light-emitting diode” (herein also referred to as an “OLED”) means: an LED having a light-emissive electroluminescent layer including an organic semiconductor, such as small organic molecules or an organic polymer. It is understood throughout this specification that a semiconductor light-emitting device may include: a non-semiconductor-substrate or a semiconductor-substrate; and may include one or more electrically-conductive contact layers. Further, it is understood throughout this specification that an LED may include a substrate formed of materials such as, for example: silicon carbide; sapphire; gallium nitride; or silicon. It is additionally understood throughout this specification that a semiconductor light-emitting device may have a cathode contact on one side and an anode contact on an opposite side, or may alternatively have both contacts on the same side of the device. The expression “LED” is used herein to refer to light-emitting diodes in any arrangement, e.g., LED chips, packaged devices (i.e., devices comprising LED chips, electrical connections, and packaging that encapsulates the light-emitting diode), etc.

Further background information regarding semiconductor light-emitting devices can be obtained in the following documents, the entireties of all of which hereby are incorporated by reference herein: U.S. Pat. Nos. 7,564,180; 7,456,499; 7,213,940; 7,095,056; 6,958,497; 6,853,010; 6,791,119; 6,600, 175; 6,201,262; 6,187,606; 6,120,600; 5,912,477; 5,739,554; 5,631,190; 5,604, 135; 5,523,589; 5,416,342; 5,393,993; 5,359,345; 5,338,944; 5,210,051; 5,027,168; 5,027,168; 4,966,862; and 4,918,497; and U.S. Patent Application Publication Nos. 2014/0225511; 2014/0078715; 2013/0241392; 2009/0184616; 2009/0080185; 2009/0050908; 2009/0050907; 2008/0308825; 2008/0198112; 2008/0179611; 2008/0173884; 2008/0121921; 2008/0012036; 2007/0253209; 2007/0223219; 2007/0170447; 2007/0158668; 2007/0139923; and 2006/0221272.

Representative specific examples of light-emitting diodes that can be used in lighting devices in accordance with the present invention include InGaN (blue light emitters and green light emitters), and AlInGaP (red light emitters), as well as others such as AlGaAs, GaAs, GaP, AlInGaN, GaN, SiC, ZnSe.

Semiconductor light-emitting devices employed in accordance with the present invention can include or not include, as desired, one or more encapsulant. In some situations, an encapsulant can be considered a lens (a primary lens), in that the pattern of light emitted from the light emitter differs from what the pattern of light would be if the encapsulant were not present.

Light-emitting devices and assemblies that comprise one or more luminescent materials can be employed in embodiments in accordance with the present invention (and/or semiconductor light-emitting devices can further comprise one or more luminescent materials). A luminescent material is a material that emits a responsive radiation (e.g., visible light) when excited by a source of exciting radiation.

Those of skill in the art are familiar with, and have ready access to, a variety of luminescent materials that emit light having a desired peak emission wavelength and/or dominant emission wavelength, or a desired hue, and any of such luminescent materials, or any combinations of such luminescent materials, can be employed, if desired.

One type of luminescent material are phosphors, which are readily available and well known to persons of skill in the art. Other examples of luminescent materials include scintillators, day glow tapes and inks that glow in the visible spectrum upon illumination with ultraviolet light.

Representative specific examples of luminescent materials that can be used in lighting devices and lighting device assemblies in accordance with the present invention include YAG (cerium-doped yttrium aluminum garnet, also known as YAG:Ce), LuAG (lutetium aluminum, also known as LuAG:Ce), CaAlSiN:Eu²⁺ (aka “CASN” or “BR01”), and BOSE.

One or more luminescent materials, if employed, can be provided in any suitable form. For example, luminescent material can be embedded in a resin (i.e., a polymeric matrix), such as a silicone material, an epoxy material, a glass material or a metal oxide material, and/or can be applied to one or more surfaces of a resin, e.g., as an encapsulant and/or in a lens or lenses for one or more semiconductor light-emitting devices.

As noted above, in some embodiments in accordance with the present invention, the lighting device or the lighting device assembly further comprises circuitry that carries current through each of the plurality of semiconductor light-emitting devices, and/or circuitry that converts AC voltage to DC voltage.

Circuitry that carries current through each of the plurality of semiconductor light-emitting devices (in embodiments that include it) can comprise any of a wide variety of components and combinations of components well known to those of skill in the art. For example, the semiconductor light-emitting devices can be arranged electrically in series, can be arranged electrically in parallel, or can be arranged in any type of series-parallel arrangement.

An AC/DC power supply/driver functions to convert AC line voltage (e.g., 120 Volts AC or about 277 Volts AC) to DC voltage (of a magnitude sufficient to power each of the LEDs, i.e., the magnitude depends on the number of semiconductor light-emitting devices in the lighting device). Circuitry that converts AC voltage to DC voltage (in embodiments that include it) can comprise any of a wide variety of components and combinations of components well known to those of skill in the art, e.g., a wide variety of rectifiers are well known to those of skill in the art, e.g., including but not limited to semiconductor diodes, silicon-controlled rectifiers and other silicon-based semiconductor switches vacuum tube diodes, wet chemical cells, mercury-arc valves, stacks of copper and selenium oxide plates, and rectifier circuits can include various combinations of components, e.g., a low pass filter, a diode, a dc pass filter, and a resistive load.

Some embodiments in accordance with the present invention can comprise additional circuitry to perform any desired function or functions. For example, such circuitry (which can be provided in any suitable location in or on the lighting devices or lighting device assemblies in accordance with the present invention, e.g., on a second circuit board) can comprise components and/or combinations of components (1) to provide for compensation to adjust current based on temperature, (2) to detect different lighting control protocol input signals and convert them into a suitable protocol for controlling the semiconductor light-emitting devices in the lighting devices and lighting device assemblies in accordance with the present invention, e.g., ELV dimming, 0-10 Volt dimming, DMX (a standard for digital communication networks that are commonly used to control lighting and effects), and DALI (i.e., Digital Illumination Interface Alliance, a dedicated protocol for digital lighting control), (3) to provide for compensation for aging of the semiconductor light-emitting devices, etc.

As noted above, in some embodiments in accordance with the present invention, the lighting device or the lighting device assembly further comprises one or more housing elements (e.g., first and second housing elements that define first and second compartments). A housing element or housing elements (in embodiments that include it/them) can be made of any suitable material or combination of materials, e.g., metal (such as aluminum, or steel (e.g., stainless steel), cast iron, etc.), plastic (such as polycarbonate, ABS or PVC), or fiberglass. In such embodiments, any suitable arrangement of housing elements and/or compartments, and the respective shapes thereof, can be employed.

As noted above, in some embodiments in accordance with the present invention, the lighting device or the lighting device assembly further comprises a first circuit board and/or a second circuit board. In embodiments that comprise one or more circuit boards, the circuit board(s) can be any suitable circuit board, a wide variety of which are well known to those of skill in the art. In some embodiments, one or more circuit boards can be metal core circuit boards (which provide relatively high heat conductivity) or FR4 circuit boards.

As noted above, in some embodiments in accordance with the present invention, the lighting device or the lighting device assembly further comprises a lens holder and a plurality of lenses (e.g., total internal reflection lenses). In some of such embodiments, the lens holder is configured to hold in place each of the plurality of lenses, e.g., one lens for each semiconductor light-emitting device, but the present invention includes devices and assemblies in which there are more than one lens holder (e.g., the single lens holder can be replaced by two or more lens holders that, in combination, hold all of the lenses).

A lens holder (in embodiments that include one) can be made of any suitable material or combination of materials, e.g., metal (such as aluminum, or steel (e.g., stainless steel), cast iron, etc.), plastic (such as polycarbonate, ABS or PVC), or fiberglass. A lens holder can be of any suitable shape, so long as it assists to some degree in holding lenses in place relative to one or more of the semiconductor light-emitting devices.

Those of skill in the art are familiar with a wide range of lenses, including total internal reflection (TIR) lenses (as well as diffusers and light control elements and the like, which can likewise be employed, if desired, in devices and assemblies in accordance with the present invention), and any of such lenses can, if desired, be used in embodiments of the present invention that include lenses. Those of skill in the art can readily envision a variety of materials out of which a lens can be made (e.g., polycarbonate materials, acrylic materials, fused silica, polystyrene, etc.), and are familiar with and/or can envision a wide variety of shapes that lenses can be. Any of such materials and/or shapes can be employed in a lens in an embodiment that includes a lens. Representative examples of TIR optics lenses comprise solid shapes, formed of any suitable material or materials (e.g., clear acrylic material) designed to receive light at one end, to provide total internal reflection of a large portion of light that hits its sidewalls, and to collimate the light. Any of the lenses or lens portions described herein can provide light filtering, if desired.

As noted above, in some embodiments in accordance with the present invention, the lighting device or the lighting device assembly further comprises a porthole lens element. A porthole lens element (in embodiments that include one) comprises one or more lens portions through which light exiting the lighting device passes. These lens portions (also referred to as porthole lens portions) can be made of any suitable material or combination of materials through which at least some light can pass, a variety of which are well known and apparent to those of skill in the art (e.g., polycarbonate materials, acrylic materials, fused silica, polystyrene, etc.), and the remainder of the porthole lens element can be made of any suitable material or combination of materials, e.g., metal (such as aluminum, or steel (e.g., stainless steel), cast iron, etc.), plastic (such as polycarbonate, ABS or PVC), or fiberglass. A porthole lens element can be of any desired size and the shape. As noted above, any of the lenses or lens portions described herein can provide light filtering, if desired.

As noted above, in some embodiments in accordance with the present invention, there is provided a first housing element that has a plurality of portholes. In some of such embodiments, the portholes are aligned with porthole lens portions of a porthole lens element (and in some cases, the portholes and the porthole lens portions are aligned with lenses, and/or with reflection elements, and/or with the semiconductor light-emitting devices), whereby at least some light emitted from the plurality of semiconductor light-emitting devices passes through lens portions of the porthole lens element and through the portholes, and in some of such embodiments, at least some light emitted from the plurality of semiconductor light-emitting devices that passes through the lens portions of the porthole lens element (e.g., extraneous light, such as light that exits from an edge of a porthole lens portion, rather than from the front-facing surface of the porthole lens portion) is blocked by the first housing element, thereby providing more consistent light output and limiting striations.

As noted above, in some embodiments in accordance with the present invention, the lighting device or the lighting device assembly further comprises a harness assembly. A harness assembly (in embodiments that include one) comprises electrical conductors that provide power to the lighting device. Those of skill in the art are familiar with, and/or can envision, a wide variety of arrangements of electrical conductors that can be provided to conduct electricity to provide power to the lighting device (e.g., the arrangement can vary to provide power to any desired combinations of components in a lighting device).

As noted above, in some embodiments in accordance with the present invention, the lighting device or the lighting device assembly further comprises an interconnection assembly. An interconnection assembly (in embodiments that include it) can comprise any desired electrical connections in a lighting device or a lighting device assembly (e.g., between a first circuit board and a second circuit board on opposite sides of a base), e.g., a 4-pin cable, e.g., 56 VDC, ground, signal and 5V.

As noted above, in some embodiments in accordance with the present invention, the lighting device or the lighting device assembly further comprises one or more reflection elements. A reflection element can comprise any structure that has a surface that causes at least a portion of incident visible light, upon reaching the surface, to then propagate in one or more different directions away from the surface without passing through the surface (or the object on which the reflection surface is). Those of skill in the art are familiar with a wide variety of materials and ways to provide a reflection surface, e.g., by using a reflective material, by applying one or more reflective materials to a structure, and/or by treating a surface of a structure to be reflective (or more reflective). A representative example of a reflection surface is a surface that is 99% diffuse white reflective.

Some embodiments of lighting devices or lighting device assemblies in accordance with the present invention can further comprises one or more end covers. Some embodiments of lighting devices in accordance with the present invention comprise an end cover on each end of the lighting device. An end cover (in embodiments that include one or more of them) can cover an end of the lighting device and hold (or assist in holding) two or more housing elements in place. An end cover (in embodiments that include one or more of them) can be made of any suitable material or combination of materials, e.g., metal (such as aluminum, or steel (e.g., stainless steel), cast iron, etc.), plastic (such as polycarbonate, ABS or PVC), or fiberglass.

As noted above, in some embodiments in accordance with the present invention, the lighting device or the lighting device assembly further comprises one or more housing elements and a harness assembly. In some of such embodiments, one of the housing elements (e.g., the second, or lower, housing element) comprises at least a first portion and a second portion, and, during assembly, the harness assembly is positioned within the first portion with a male connector of the harness assembly protruding from one end of the first portion and a female connector of the harness assembly protruding from the other end of the first portion, and later (after electrical connections between the harness assembly and the power supply are made), the first portion and the second portion are pressed onto the base.

Some embodiments of lighting devices and lighting device assemblies in accordance with the present invention can further comprises one or more mounting brackets. A mounting bracket or mounting brackets (in embodiments in which they are provided) can be attached to another portion (e.g., an end cover) of a lighting device or a lighting device assembly, and provide structure (e.g., an opening that portions of the mounting bracket extend more than 180 degrees around, such as completely around, in a first plane) through which hardware (e.g., screw or bolts) can be inserted to attach the lighting device or lighting device assembly to a structure (e.g., a wall or a ceiling).

In some embodiments that comprise one or more mounting brackets, the mounting bracket(s) are pivotally attached to the remainder of the lighting device or lighting device assembly, e.g., incrementally pivotally attached, as described in U.S. Pat. No. 9,651,227, the entirety of which-including disclosure relating to mounting brackets-is hereby incorporated herein by reference. By providing one or more mounting brackets that are pivotally attached to the remainder of the lighting device or lighting device assembly, the rest of the lighting device or lighting device assembly is pivotable relative to the mounting bracket(s), so that once installed, the rest of the lighting device or lighting device assembly can easily be pivoted to a desired orientation relative to the structure to which the mounting bracket(s) are mounted.

Some embodiments of lighting devices and lighting device assemblies in accordance with the present invention can further comprise one or more thermal pads. A thermal pad or thermal pads (in embodiments in which they are provided) can increase the rate of heat dissipation, e.g., from high temperature components (e.g., a power supply) to the base, by increasing the rate of heat transfer. Those of skill in the art are familiar with a wide variety of thermal pads, and any of such thermal pads can be employed in lighting devices and lighting device assemblies in accordance with the present invention.

Some embodiments of lighting devices and lighting device assemblies in accordance with the present invention can further comprise one or more vents, e.g., adhesive vents. A vent or vents (in embodiments in which they are provided) can allow for pressure to equalize between the interior of a compartment (e.g., within a housing element, e.g., due to temperature changes) and the exterior, while being weather-tight (e.g., preventing moisture from entering into the compartment). Those of skill in the art are familiar with a wide variety of vents (e.g., adhesive vents), and any of such vents can be employed in lighting devices and lighting device assemblies in accordance with the present invention.

Detailed descriptions of embodiments that correspond to the present invention (and/or aspects of the present invention), and detailed descriptions of features that are provided in some embodiments in accordance with the present invention, are provided hereinafter, in many instances with reference to the accompanying drawings, in which representative embodiments in accordance with the present invention are shown. These detailed descriptions of specific aspects of the present invention, and embodiments in accordance with the present invention, are provided to describe features of the present invention with reference to a specific embodiment or embodiments. The present invention should not be construed as being limited to the specific features in the embodiments set forth herein.

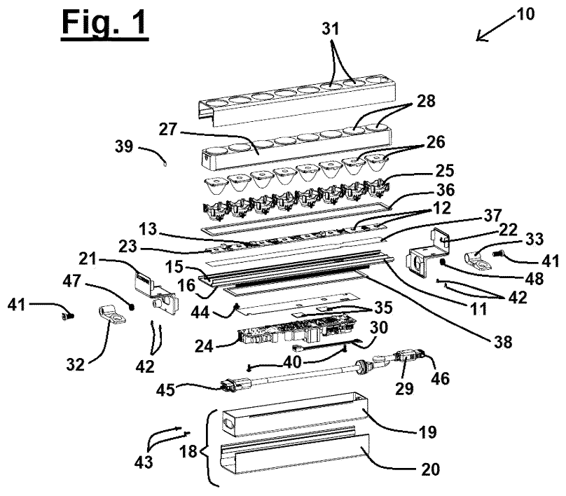

FIG. 1 is an exploded view of a first embodiment of a lighting device 10 in accordance with the present invention. The lighting device 10 comprises a base 11, a plurality of light emitting diodes 12, circuitry 13 that carries current through each of the plurality of light emitting diodes, and a power supply 14 (comprising circuitry that converts AC voltage to DC voltage). The plurality of light emitting diodes 12 and the circuitry 13 are on a first side 15 of the base 11, and the power supply 14 is on a second side 16 of the base 11. The first side 15 of the base 11 is opposite the second side 16 of the base 11. The first side 15 of the base 11 and the second side 16 of the base 11 are both substantially flat and substantially rectangular, and the length of the first side 15 of the base 11 is at least four times (as seen in FIG. 1, more than four times) the width of the first side 15 of the base 11. (Also, the length of the second side 16 of the base 11 is more than four times the width of the second side 16 of the base 11.)

The thickness of the base 11, in a direction that is perpendicular to the first side 15 of the base 11 and the second side 16 of the base 11, is not greater than one tenth of the length of the first side 15 of the base 11.

As shown in FIG. 1, the light emitting diodes 12 are all arranged in a row.

As shown in FIG. 1, the lighting device 10 also comprises a first housing element 17, a second housing element 18 (which comprises a second housing element first portion 19 and a second housing element second portion 20), a first end cover 21, a second end cover 22, a first circuit board 23, a second circuit board 24, a lens holder 25, a plurality of total internal reflection (TIR) lenses 26, a porthole lens element 27, a harness assembly 29, and an interconnection assembly 30.

The harness assembly 29 comprises electrical conductors that provide power to the lighting device 10.

The interconnection assembly 30 provides electrical connections between the first circuit board 23 and the second circuit board 24.

The first circuit board 23 is on the first side 15 of the base 11, and the plurality of light emitting diodes 12 and the circuitry 13 are on the first circuit board 23.

The second circuit board 24 is on the second side 16 of the base 11, and the power supply 14 is on the second circuit board 24. In addition, also provided on the second circuit board 24 is compensation circuitry to adjust current based on temperature, and circuitry to detect different four different lighting control protocols, namely, ELV, 0-10 Volt dimming, DMX, and DALI, to control the semiconductor light-emitting devices.

The first housing element 17 comprises a plurality of portholes 31.

The porthole lens element 27 comprises a plurality of lens portions 28.

The lens holder 25 holds the plurality of TIR lenses 26 in place.

The light emitting diodes 12, the TIR lenses 26, the lens portions 28 of the porthole lens element 27, and the portholes 31 in the first housing element 17 are aligned, such that light emitted from each light emitting diode 12 passes through a respective one of the TIR lenses 26, a respective one of the lens portions 28, and a respective one of the portholes 31. In the embodiment depicted in FIG. 1, for each light emitting diode 12, an axis of light emission of the light emitting diode 12 is substantially co-linear with an axis of its respective TIR lens 26, the center of its respective lens portion 28, and the center of its respective porthole 31. By passing through one of the TIR lenses 26 and one of the lens portions 28, light that was emitted from each of the light emitting diodes 12 and that exits the lighting device 10 is collimated to a greater extent than when it exited the light emitting diode 12.

The harness assembly 29 comprises a male connector 45 and a female connector 46.

The lighting device 10 further comprises a first mounting bracket 32, a second mounting bracket 33, an insulation sheet 34, thermal pads 35, a first gasket 36, double-sided thermal tape 37, a second gasket 38, and an adhesive vent 39.

The first housing element 17 and the first side 15 of the base 11 define (in part) a first internal compartment (the first internal compartment is completely surrounded, or substantially completely surrounded, by the first housing element 17, the first side 15 of the base 11, the lens portions 28, a first portion of the first end cover 21 and a first portion of the second end cover 22). The double-sided thermal tape 37, the first circuit board 23, the light emitting diodes 12, the circuitry 13, the first gasket 36, the lens holder 25, and the TIR lenses 26 are all in the first internal compartment.

The second housing element 18 and the second side 16 of the base 11 define (in part) a second internal compartment (the second internal compartment is completely surrounded, or substantially completely surrounded, by the second housing element 18, the second side 16 of the base 11, a second portion of the first end cover 21, a second portion of the second end cover 22, and portions of the harness assembly). The second gasket 38, the insulation sheet 34, the thermal pads 35, the second circuit board 24, the power supply 14, and a majority of the harness assembly 29 are all in the second internal compartment. The interconnection assembly 30 is in the first internal compartment or the second internal compartment; alternatively, part of the interconnection assembly 30 is in the first internal compartment, part of the interconnection assembly is in the second internal compartment, and part of the interconnection assembly 30 extends through an opening in the base 11.

The embodiment depicted in FIG. 1 also comprises:
screws 40 that connect the first circuit board 23 to the base 11,
screws 41 that respectively connect: the first mounting bracket 32 and a first disc spring 47 to the first end cover 21, and the second mounting bracket 33 and a second disc spring 48 to the second end cover 22,
screws 42 that respectively connect: the first end cover 22 to the base 11, and the second end cover 23 to the base 11,
screws 43 that screw into the male connector 45 of the harness assembly 29 through the second housing element first portion 19, and
a screw 44 that connects a ground wire of the harness assembly 29 to the base 11 to provide grounding.

The base 11 comprises an entirety of a one-piece structure.

More than 75 percent of points on the exterior of the first side 15 of the base 11 are base-obstruction-free in more than 80 percent of all directions away from the first side 15 of the base, and more than 75 percent of points on the exterior of the second side 16 of the base 11 are base-obstruction-free in more than 80 percent of all directions away from the second side 16 of the base 11.

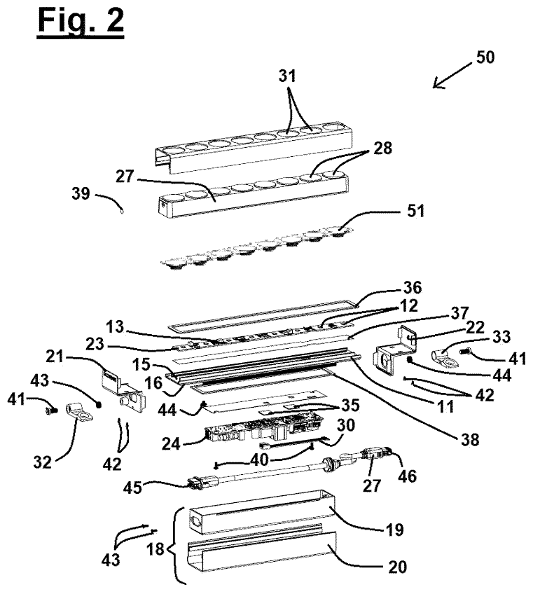

FIG. 2 is an exploded view of a second embodiment of a lighting device 50 in accordance with the present invention. The lighting device 50 is similar to the lighting device 10 depicted in FIG. 1, except that the lighting device 50 does not include a lens holder 25, the lighting device 50 does not include TIR lenses 26, and the lighting device 50 includes a reflection element 51 (whereas the lighting device 10 does not include a reflection element 51). In the second embodiment of a lighting device 50 depicted in FIG. 2, items that correspond to items in the embodiment of a lighting device 10 depicted in FIG. 1 are identified with like reference numbers.

In the lighting device 50, the light emitting diodes 12, respective portions of the reflection element 51, the lens portions 28 of the porthole lens element 27, and the portholes 31 in the first housing element 17 are aligned, such that light emitted from each light emitting diode 12 passes through a space defined by a respective reflective portion of the reflection element 51, a respective one of the lens portions 28, and a respective one of the portholes 31. In the embodiment depicted in FIG. 2, for each light emitting diode 12, an axis of light emission of the light emitting diode 12 is substantially co-linear with an axis of its respective portion of the reflection element 51, the center of its respective lens portion 28, and the center of its respective porthole 31. By passing through a respective portion of the reflection element 51 and one of the lens portions 28, light that was emitted from each of the light emitting diodes 12 and that exits the lighting device 10 is collimated to a greater extent than when it exited the light emitting diode 12.

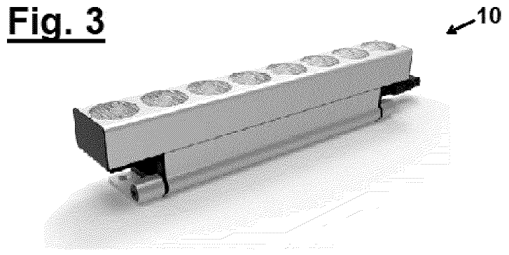

FIG. 3 is a perspective view of the lighting device 10 (assembled). The assembled lighting device 50 has a similar appearance to FIG. 3.

Below is a discussion of a first embodiment of a method in accordance with the present invention, for assembling a lighting device corresponding to the lighting device 10.

Step 1: The semiconductor light-emitting devices 12 and the circuitry 13 (and any other desired components) are mounted on the first side of the first circuit board 23, and then the double-sided thermal tape 37 is attached to the second side of the first circuit board 23. In this discussion, the “first side” of any item refers to the upper side of the item if the lighting device is in the orientation depicted in FIGS. 1 and 2, and the “second side” of any item refers to the lower side of the item if the lighting devices is in the orientation depicted in FIGS. 1 and 2.

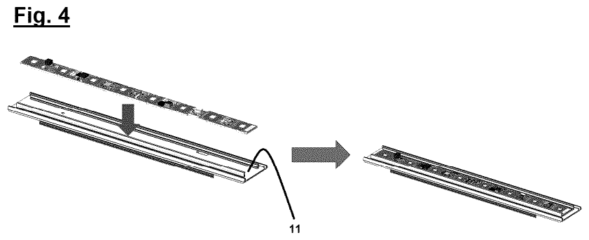

Step 2: The Step 1 assembly is mounted on the base 11 (see FIG. 4).

Step 3: The first gasket 36 is attached (on its adhesive side) to the first side of the Step 2 assembly.

Step 4: The interconnection assembly 30 is mounted on the Step 3 assembly, so that an electrical connector passes through a slot in the base 11, and is connected to a housing connector on the first circuit board 23.

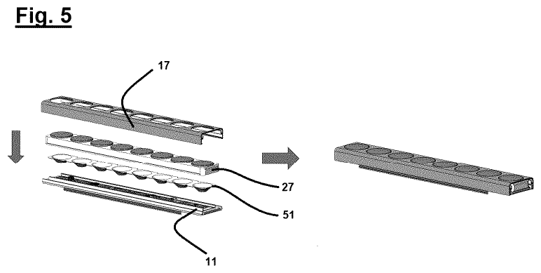

Step 5: The first housing element 17, the porthole lens element 27, the lens holder 25 and the TIR lenses 26 are arranged, and the first housing element 17 is pressed onto the base 11 by a press machine (see FIG. 5).

Step 6: The second gasket is attached (on its adhesive side) to the second side of the base 11.

Step 7: The insulation sheet 34 is attached to the Step 6 assembly.

Step 8: The thermal pads 35 are attached to the Step 7 assembly.

Step 9: The second circuit board (with the power supply 14 and any other desired components mounted thereon) is attached (with the screws 40) to the Step 8 assembly, and electrically connected to the interconnection assembly 30.

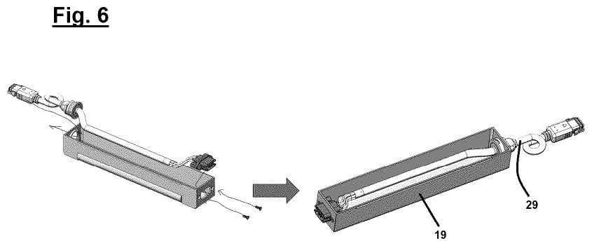

Step 10: The harness assembly 29 is positioned within the second housing element first portion 19 with its male connector 45 protruding from one end of the second housing element first portion 19 and its female connector 46 protruding from the other end of the second housing element first portion 19, and the screws 43 are screwed into the male connector 45 through the second housing element first portion 19 (see FIG. 6).

Step 11: All other electrical connections are made (e.g., between the harness assembly 29 and the power supply 14).

Step 12: The second housing element 18 (including the second housing element first portion 19 and the second housing element second portion 20) is pressed onto the base 11.

Step 13: The Step 12 assembly is tested for its sealing effectiveness against the intrusion of solid particles and liquid (IP test), and if it passes, the adhesive vent 39 is applied over an opening in the porthole lens element 27.

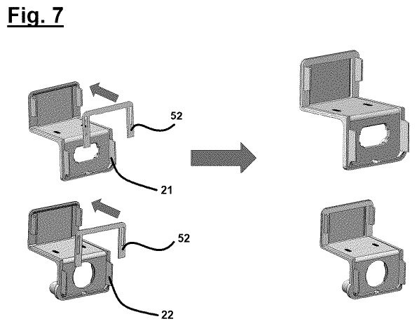

Step 14: Light-blocking foam 52 is applied (on its adhesive side) to the first end cover 21 and the second end cover 22 (see FIG. 7).

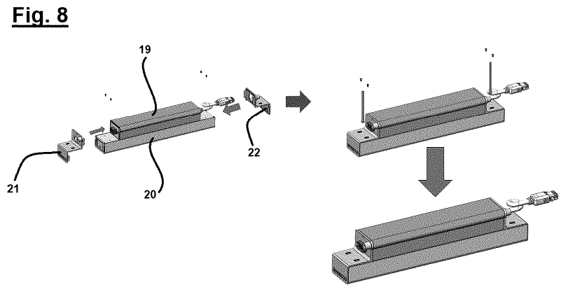

Step 15: The Step 14 sub-assemblies are attached to the Step 13 assembly with the screws 43 (see FIG. 8).

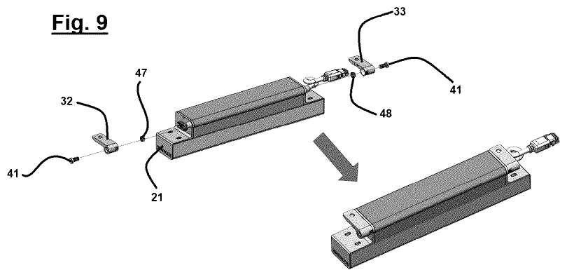

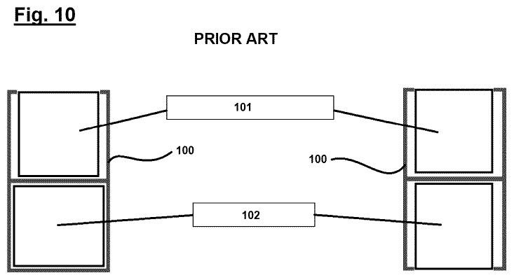

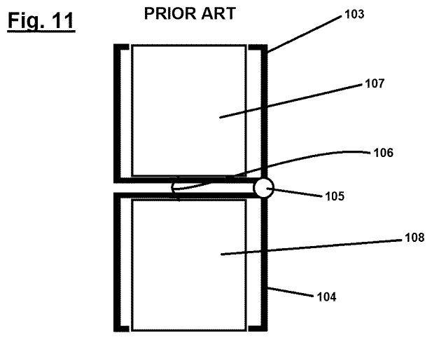

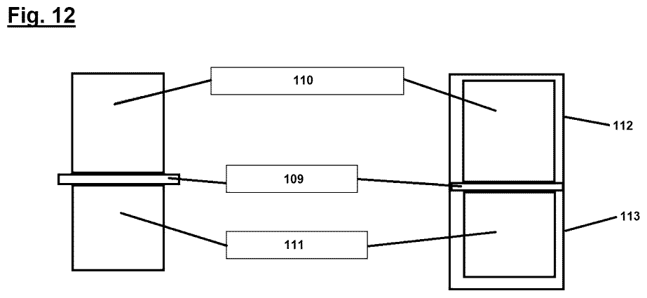

Step 16: The first and second mounting brackets 32 and 33, and the first and second disc springs 47 and 48 are attached to the Step 15 assembly by passing each of the screws 41 through a respective mounting bracket and disc spring, and threading into a respective end cover (see FIG. 9).

A second embodiment of a method in accordance with the present invention, for assembling a lighting device corresponding to the lighting device 50, is similar to the first embodiment of a method in accordance with the present invention, except that in Step 5, instead of the first housing element 17, the porthole lens element 27, the lens holder 25 and the TIR lenses 26 being arranged, and the first housing element 17 being pressed onto the base 11 by a press machine, the first housing element 17, the porthole lens element 27, and the reflection element 51 are arranged, and the first housing element 17 is pressed onto the base 11 by a press machine.

In some embodiments in accordance with the present invention, including some embodiments that include or do not include any of the features described herein, there is provided a lighting device, comprising:
a base;
a plurality of semiconductor light-emitting devices;
a first housing element and a second housing element;
a first internal compartment and a second internal compartment;
a first circuit board;
circuitry that carries current through each of the plurality of semiconductor light-emitting devices;
a lens holder;
a plurality of total internal reflection lenses;
a porthole lens element;
a second circuit board;
circuitry that converts AC voltage to DC voltage;
a harness assembly; and
an interconnection assembly,
   wherein:
the plurality of semiconductor light-emitting devices are on a first side of the base,
the first side of the base is opposite a second side of the base,
the first side of the base and the second side of the base are the largest sides of the base,
the first side of the base and the second side of the base are both substantially flat and substantially rectangular,
a length of the first side of the base is at least four times a width of the first side of the base,
the first internal compartment is defined at least in part by the first housing element and the first side of the base,
the plurality of semiconductor light-emitting devices, the first circuit board, the circuitry that carries current through each of the plurality of semiconductor light-emitting devices, the lens holder, the plurality of lenses, and the porthole lens element are in the first compartment,
the first circuit board is on the first side of the base,
the plurality of semiconductor light-emitting devices and the circuitry that carries current through each of the plurality of semiconductor light-emitting devices are on the first circuit board,
the plurality of lenses are held in position by the lens holder,
the first housing element comprises a plurality of portholes,
the second internal compartment is defined at least in part by the second housing element and the second side of the base,
the second circuit board is on the second side of the base,
the circuitry that converts AC voltage to DC voltage is on the second circuit board,
the harness assembly comprises electrical conductors that provide power to the lighting device,
the interconnection assembly provides electrical connections between the first circuit board and the second circuit board, and
the second circuit board, the circuitry that converts AC voltage to DC voltage, and the harness assembly are in the second compartment.

In some embodiments in accordance with the present invention, including some embodiments that include or do not include any of the features described herein, there is provided a lighting device, comprising:
a base;
a plurality of semiconductor light-emitting devices;
a first housing element and a second housing element;
at least a first internal compartment and a second internal compartment;
a first circuit board;
circuitry that carries current through each of the plurality of semiconductor light-emitting devices;
a reflection element;
a porthole lens element;
a second circuit board;
circuitry that converts AC voltage to DC voltage;
a harness assembly; and
an interconnection assembly,
   wherein:
the plurality of semiconductor light-emitting devices are on a first side of the base,
the first side of the base is opposite a second side of the base,
the first side of the base and the second side of the base are the largest sides of the base,
the first side of the base and the second side of the base are both substantially flat and substantially rectangular,
a length of the first side of the base is at least four times a width of the first side of the base,
the first internal compartment is defined at least in part by the first housing element and the first side of the base,
the plurality of semiconductor light-emitting devices, the first circuit board, the circuitry that carries current through each of the plurality of semiconductor light-emitting devices, the reflection element, and the porthole lens element are in the first internal compartment,
the first circuit board is on the first side of the base,
the plurality of semiconductor light-emitting devices and the circuitry that carries current through each of the plurality of semiconductor light-emitting devices are on the first circuit board,
the first housing element comprises a plurality of portholes,
the second internal compartment is defined at least in part by the second housing element and the second side of the base,
the second circuit board is on the second side of the base,
the circuitry that converts AC voltage to DC voltage is on the second circuit board,
the harness assembly comprises electrical conductors that provide power to the lighting device,
the interconnection assembly provides electrical connections between the first circuit board and the second circuit board, and
the second circuit board, the circuitry that converts AC voltage to DC voltage, and the harness assembly are in the second compartment.

In some embodiments in accordance with the present invention, including some embodiments that include or do not include any of the features described herein, there is provided a lighting device, comprising:
a base;
a plurality of semiconductor light-emitting devices;
a first housing element and a second housing element;
at least a first internal compartment and a second internal compartment;
a first circuit board;
circuitry that carries current through each of the plurality of semiconductor light-emitting devices;
a lens holder;
a plurality of total internal reflection lenses;
a porthole lens element;
a second circuit board;
circuitry that converts AC voltage to DC voltage;
a harness assembly; and
an interconnection assembly,
   wherein:
the plurality of semiconductor light-emitting devices are on a first side of the base,
the base comprises an entirety of a one-piece structure,
at least 75 percent of points on an exterior of the first side of the base are base-obstruction-free in at least 80 percent of all directions away from the first side,
at least 75 percent of points on an exterior of the second side of the base are base-obstruction-free in at least 80 percent of all directions away from the second side,
the first internal compartment is defined at least in part by the first housing element and the first side of the base,
the plurality of semiconductor light-emitting devices, the first circuit board, the circuitry that carries current through each of the plurality of semiconductor light-emitting devices, the lens holder, the plurality of lenses, and the porthole lens element are in the first compartment,
the second side of the base is opposite the first side of the base,
the first circuit board is on the first side of the base,
the plurality of semiconductor light-emitting devices and the circuitry that carries current through each of the plurality of semiconductor light-emitting devices are on the first circuit board,
the plurality of lenses are held in position by the lens holder,
the first housing element comprises a plurality of portholes,
the second internal compartment is defined at least in part by the second housing element and the second side of the base,
the second circuit board is on a second side of the base,
the circuitry that converts AC voltage to DC voltage is on the second circuit board,
the harness assembly comprises electrical conductors that provide power to the lighting device,
the interconnection assembly provides electrical connections between the first circuit board and the second circuit board, and
the second circuit board, the circuitry that converts AC voltage to DC voltage, and the harness assembly are in the second compartment.

In some embodiments in accordance with the present invention, including some embodiments that include or do not include any of the features described herein, there is provided a lighting device, comprising:
a base;
a plurality of semiconductor light-emitting devices;
a first housing element and a second housing element;
at least a first internal compartment and a second internal compartment;
a first circuit board;
circuitry that carries current through each of the plurality of semiconductor light-emitting devices;
a reflection element;
a porthole lens element;
a second circuit board;
circuitry that converts AC voltage to DC voltage;
a harness assembly; and
an interconnection assembly,
   wherein:
the plurality of semiconductor light-emitting devices are on a first side of the base,
the base comprises an entirety of a one-piece structure,
at least 75 percent of points on an exterior of the first side of the base are base-obstruction-free in at least 80 percent of all directions away from the first side,
at least 75 percent of points on an exterior of the second side of the base are base-obstruction-free in at least 80 percent of all directions away from the second side,
the first internal compartment is defined at least in part by the first housing element and the first side of the base,
the plurality of semiconductor light-emitting devices, the first circuit board, the circuitry that carries current through each of the plurality of semiconductor light-emitting devices, the reflection element, and the porthole lens element are in the first compartment,
the second side of the base is opposite the first side of the base,
the first circuit board is on the first side of the base,
the plurality of semiconductor light-emitting devices and the circuitry that carries current through each of the plurality of semiconductor light-emitting devices are on the first circuit board,
the first housing element comprises a plurality of portholes,
the second internal compartment is defined at least in part by the second housing element and a second side of the base,
the second circuit board is on a second side of the base,
the circuitry that converts AC voltage to DC voltage is on the second circuit board,
the harness assembly comprises electrical conductors that provide power to the lighting device,
the interconnection assembly provides electrical connections between the first circuit board and the second circuit board, and
the second circuit board, the circuitry that converts AC voltage to DC voltage, and the harness assembly are in the second compartment.

Any two or more structural parts of the lighting devices and lighting device assemblies described herein can be integrated. Any structural part of the lighting devices and lighting device assemblies described herein can be provided in two or more parts.

Each component described herein can be a unitary one-piece structure. In some cases, if suitable, two or more structural parts of the devices described herein can be integrated, and/or a component can be provided in two or more parts (which are held together, if necessary). In some embodiments, any two or more functions can be conducted simultaneously, and/or any function can be conducted in a series of steps.

Furthermore, while certain embodiments of the present invention have been illustrated with reference to specific combinations of elements and attributes, various other combinations may also be provided without departing from the teachings of the present invention. Thus, the present invention should not be construed as being limited to the particular exemplary embodiments described herein and illustrated in the Figures, but may also encompass combinations of elements and attributes of the various illustrated embodiments.

Based on the information provided in the present disclosure, many alterations and modifications may be made by those having ordinary skill in the art, given the benefit of the present disclosure, without departing from the teaching of the present specification, and/or without departing from the spirit and scope of the present invention.

1. A lighting device assembly comprising:
a base;
a plurality of semiconductor light-emitting devices;
circuity that carries current through each of the plurality of semiconductor light-emitting devices; and
circuitry that converts AC voltage to DC voltage,
the plurality of semiconductor light-emitting devices are on a first side of the base,
the first side of the base is opposite a second side of the base,
the first side of the base and the second side of the base are the largest sides of the base,
the first side of the base and the second side of the base are both substantially flat and substantially rectangular,
a length of the first side of the base is at least four times a width of the first side of the base,
the circuitry that carries current through each of the plurality of semiconductor light-emitting devices is on the first side of the base, and
the circuitry that converts AC voltage to DC voltage is on the second side of the base.

2. A lighting device assembly as recited in claim 1, wherein:
the length of the first side of the base is at least ten inches, and
the width of the first side of the base is not greater than three inches.

3. (canceled)

4. A lighting device assembly as recited in claim 1, wherein the plurality of semiconductor light-emitting devices are all arranged in a row.

5. A lighting device assembly as recited in claim 1, wherein:
the lighting device assembly further comprises a first housing element and a second housing element,
the lighting device assembly comprises at least a first internal compartment and a second internal compartment,
the first internal compartment is defined at least in part by the first housing element and the first side of the base,
the plurality of semiconductor light-emitting devices are in the first internal compartment, and
the second internal compartment is defined at least in part by the second housing element and the second side of the base.

6. A lighting device assembly as recited in claim 1, wherein:
the lighting device assembly further comprises a first circuit board,
the first circuit board is on the first side of the base,
the plurality of semiconductor light-emitting devices are on the first circuit board,
the lighting device assembly further comprises a second circuit board, and
the second circuit board is on the second side of the base.

7. A lighting device assembly as recited in claim 1, wherein:
the lighting device assembly further comprises a first housing element and a lens element,
the first housing element comprises a plurality of portholes,
at least some light emitted from the plurality of semiconductor light-emitting devices passes through lens portions of the lens element and through the portholes, and
at least some of the light emitted from the plurality of semiconductor light-emitting devices that passes through the lens portions of the lens element is blocked by the first housing element.

8. (canceled)

9. A lighting device assembly as recited in claim 21, wherein:
the first side of the base and the second side of the base are both substantially flat and substantially rectangular, and
a length of the first side of the base is at least four times a width of the first side of the base.

10. A lighting device assembly as recited in claim 21, wherein:
a length of the first side of the base is at least ten inches, and
a width of the first side of the base is not greater than three inches.

11. A lighting device assembly as recited in claim 21, wherein:
the lighting device assembly further comprises circuitry that carries current through each of the plurality of semiconductor light-emitting devices, and circuitry that converts AC voltage to DC voltage,
the circuitry that carries current through each of the plurality of semiconductor light-emitting devices is on the first side of the base,
the circuitry that converts AC voltage to DC voltage is on a second side of the base, and
the second side of the base is opposite the first side of the base.

12. A lighting device assembly as recited in claim 21, wherein the plurality of semiconductor light-emitting devices are all arranged in a row.

13. (canceled)

14. A lighting device assembly as recited in claim 21, wherein:
the lighting device assembly further comprises a first circuit board,
the first circuit board is on the first side of the base,
the plurality of semiconductor light-emitting devices are on the first circuit board,
the lighting device assembly further comprises a second circuit board,
the second circuit board is on the second side of the base, and
the second side of the base is opposite the first side of the base.

15. A lighting device assembly as recited in claim 1, wherein:
the lighting device assembly further comprises a first housing element and a lens element,
the first housing element comprises a plurality of portholes,
at least some light emitted from the plurality of semiconductor light-emitting devices passes through lens portions of the lens element and through the portholes, and
at least some light emitted from the plurality of semiconductor light-emitting devices passes through the lens portions of the lens element is blocked by the first housing element.

16. A method of making a lighting device assembly, comprising:
mounting a plurality of semiconductor light-emitting devices on a first circuit board;
attaching the first circuit board to a base, the base comprising a first side and a second side, the first side of the base is opposite the second side of the base, the first side of the base and the second side of the base are the largest sides of the base, the first side of the base and the second side of the base are both substantially flat and substantially rectangular, and a length of the first side of the base is at least four times a width of the first side of the base;
attaching a first housing element to the base, so that the first circuit board and the plurality of semiconductor light-emitting devices are within a space defined by the first housing element and the base;
mounting a power supply on a second circuit board;
attaching the second circuit board to a second side of the base; and
attaching a second housing element to the base, so that the second circuit board and the power supply are within a space defined by the second housing element and the base,
wherein:
said attaching a first housing element to the base is performed after said attaching the first circuit board to the first side of the base, and after said mounting the plurality of semiconductor light-emitting devices on the first circuit board, and
said attaching a second housing element to the base is performed after said mounting the power supply on the second circuit board, and after said attaching the second circuit board to the second side of the base.

17. A method as recited in claim 16, wherein:
the method further comprises:
attaching an interconnection assembly to the base and electrically connecting wires in the interconnection assembly to the second circuit board before at least one of said attaching the first housing element to the base and said attaching the second housing element to the base;
positioning a harness assembly in the second housing element, and electrically connecting wires in the harness assembly to components on the second circuit board before said attaching the second housing element to the base; and
before said attaching the first housing element to the base, positioning a lens element such that upon said attaching the first housing element to the base, the lens element is within the space defined by the first housing element and the base.

18. A method as recited in claim 16, wherein the method further comprises:
before said attaching the first housing element to the base, positioning a lens holder and a plurality of lenses such that upon said attaching the first housing element to the base, the lens holder and the plurality of lenses are within the space defined by the first housing element and the base.

19. A method as recited in claim 16, wherein the method further comprises:
before said attaching the first housing element to the base, positioning a reflection element such that upon said attaching the first housing element to the base, the reflection element is within the space defined by the first housing element and the base.

20. A method as recited in claim 16, wherein:
the method further comprises positioning a harness assembly in the second housing element, and electrically connecting wires in the harness assembly to components on the second circuit board before said attaching the second housing element to the base, and
the second housing element comprises a second housing element first portion and a second housing element second portion, and the harness assembly is positioned in the second housing element second portion before the second housing element is attached to the base.

21. A lighting device assembly comprising:
a base;
a plurality of semiconductor light-emitting devices;
a first housing element;
a second housing element;
a first internal compartment; and
a second internal compartment,
the plurality of semiconductor light-emitting devices are on a first side of the base,
the first side of the base is opposite a second side of the base,
the first side of the base and the second side of the base are the largest sides of the base,
the first internal compartment is defined at least in part by the first housing element and the first side of the base,
the plurality of semiconductor light-emitting devices are in the first internal compartment,
the second internal compartment is defined at least in part by the second housing element and a second side of the base, and
the second side of the base is opposite the first side of the base.
